(19) United States
(12) Patent Application Publication
(10) Pub. No.: US 2016/0276716 A1
(43) Pub. Date: Sep. 22, 2016

(54) JIG APPARATUS

(71) Applicant: SAMSUNG SDI CO., LTD., Yongin-si (KR)

(72) Inventor: Dong-Hyun LEE, Yongin-si (KR)

(21) Appl. No.: 14/807,802

(22) Filed: Jul. 23, 2015

(30) Foreign Application Priority Data
Mar. 16, 2015 (KR) 10-2015-0035999

(51) Int. Cl. H01M 10/42

(52) U.S. Cl. CPC H01M 10/4285

(57) ABSTRACT

A jig apparatus includes: a base member having a size corresponding to a lower side of a rechargeable battery in which a terminal is not formed; and a first rotation member rotatably coupled to an upper side of the base member.

### CROSS-REFERENCE TO RELATED APPLICATION

This application claims priority to and the benefit of Korean Patent Application No. 10-2015-0035999, filed on Mar. 16, 2015 in the Korean Intellectual Property Office, the entire content of which is incorporated herein by reference.

### BACKGROUND

1. Field

Aspects of embodiments of the present invention relate generally to a jig apparatus and, more particularly, to a jig apparatus for testing a cycle-life of a rechargeable battery.

2. Description of the Related Art

A rechargeable battery can be repeatedly charged and discharged, unlike a primary battery that is incapable of being recharged. A low-capacity rechargeable battery may be used for small electronic devices, such as a mobile phone, a laptop computer, or a camcorder, and a large-capacity battery has been widely used as a power source for driving a motor, such as a motor for powering a hybrid vehicle or an electric vehicle.

To test a cycle-life of the rechargeable battery, a probe is connected to each terminal, of the rechargeable battery, Particularly, in a case of a rivet-type terminal, the cycle-life of the rechargeable battery may only be tested by direct contact. This test is generally carried out for six months to over a year. In this case, when the probe and the terminal contact each other by a point contact rather than a surface contact, heat is generated by the increased contact resistance, so a test result value is derived by lower performance than actual performance of the battery by the heat, thereby decreasing reliability of the result.

The above information disclosed in this Background section is only for enhancement of understanding of the background of the described technology and therefore it may contain information that does not form the prior art that is already known in this country to a person of ordinary skill in the art.

### SUMMARY

According to an aspect of one or more exemplary embodiments of the present invention, a jig apparatus is configured to stably bring a probe and a terminal into surface contact.

A jig apparatus according to one or more embodiments of the present invention includes: a base member having a size corresponding to a lower side of a rechargeable battery in which a terminal is not formed; and a first rotation member rotatably coupled to an upper side of the base member.

The jig apparatus may further include two first hinge portions respectively arranged at opposite ends of the upper side of the base member to rotate the first rotation member in a first direction with respect to the base member.

The jig apparatus may further include an adhesive layer on an upper surface of the first rotation member to adhere the first rotation member to a lower surface of a rechargeable battery.

A jig apparatus according to one or more embodiments of the present invention includes a base member having a size corresponding to a probe installed to a terminal arranged at an upper side of a rechargeable battery; a first rotation member rotatably coupled to an upper side of the base member, the first rotation member being rotatable relative to the base member about a first rotation axis and a second rotation member rotatably coupled to an upper side of the first rotation member, the second rotation member being rotatable relative to the first rotation member about a second rotation axis that is perpendicular to the first rotation axis.

The jig apparatus may further include: two first hinge portions respectively arranged at opposite ends of the upper side of the base member in a lengthwise direction to rotate the first rotation member with respect to the base member about the first rotation axis; and two second hinge portions respectively arranged at opposite ends of the first rotation member in a lateral direction to rotate the second rotation member with respect to the first rotation member about the second rotation axis.

The jig apparatus may further include an adhesive layer on a lower surface of the base member to adhere the base member to an upper surface of a probe.

The jig apparatus may further include a probe in close surface contact with a lower surface of the base member. The jig apparatus may further include an adhesive layer on the lower surface of the base member to adhere the base member to a surface of the probe.

The jig apparatus according to one or more exemplary embodiments includes a first rotation member. The rechargeable battery may be moved by the first rotation member such that the rechargeable battery may be stably close in the contact state with the probe.

According to an aspect of embodiments of the present invention, a probe and a terminal of a rechargeable battery are in surface contact with each other such that a contact resistance is not increased, thereby preventing or substantially preventing heating from being generated. Therefore, when testing the cycle-life of the rechargeable battery, the performance of the rechargeable battery may be measured or obtained with an accurate result value.

### BRIEF DESCRIPTION OF THE DRAWINGS

FIG. 1 is a perspective view of a jig apparatus and a rechargeable battery, according to an exemplary embodiment of the present invention.

FIG. 2 is a side view of the jig apparatus and the rechargeable battery shown in FIG. 1.

FIG. 3 is a graph of cycle-life according to temperatures of two rechargeable batteries.

FIG. 4 is a perspective view showing a jig apparatus according to another exemplary embodiment of the present invention.

FIG. 5 is a front view showing a state in which the jig apparatus of FIG. 4 is installed to a probe on a rechargeable battery.

FIG. 6 is a graph showing a cycle-life of a rechargeable battery by using a jig apparatus according to an exemplary embodiment of the present invention and a conventional jig apparatus.

Description of Reference Numerals Indicating
Some Elements in the Drawings

| | |
|---|---|
| 10: rechargeable battery | 11, 12: terminal |
| 20: probe | |
| 100, 200: jig apparatus | 110, 210: base member |
| 120, 220: first rotation member | 230: second rotation member |
| H1: first hinge portion | H2: second hinge portion |

### DETAILED DESCRIPTION

Aspects and features of embodiments of the present invention will be described more fully hereinafter with reference to the accompanying drawings, in which some exemplary embodiments of the invention are shown and described by way of illustration. As those skilled in the art would realize, the described embodiments may be modified in various different ways, all without departing from the spirit or scope of the present invention. Accordingly, the drawings and description are to be regarded as illustrative in nature and not restrictive.

Like reference numerals are given to the same or similar constituent elements through the specification and drawings.

Further, in the described exemplary embodiments, components having the same configurations are designated by the same reference numerals and described in the representative exemplary embodiment, and other configurations that are different from the representative exemplary embodiment are described with respect to other exemplary embodiments.

Throughout this specification and the claims that follow, when it is described that an element is “coupled” to another element, the element may be “directly coupled” to the other element or “indirectly coupled” to the other element through a third element. In addition, unless explicitly described to the contrary, the word “comprise” and variations such as “comprises” or “comprising” will be understood to imply the inclusion of stated elements but not the exclusion of other elements.

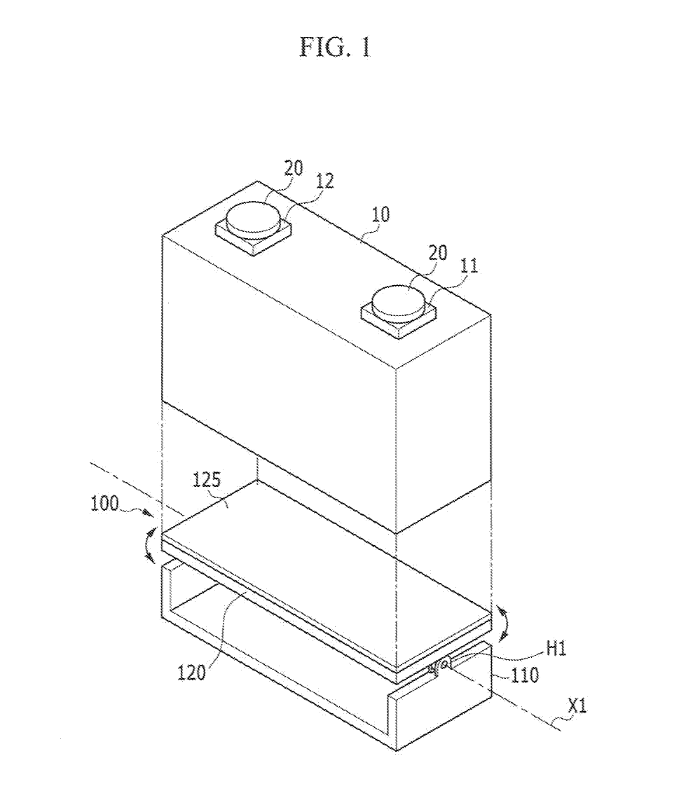

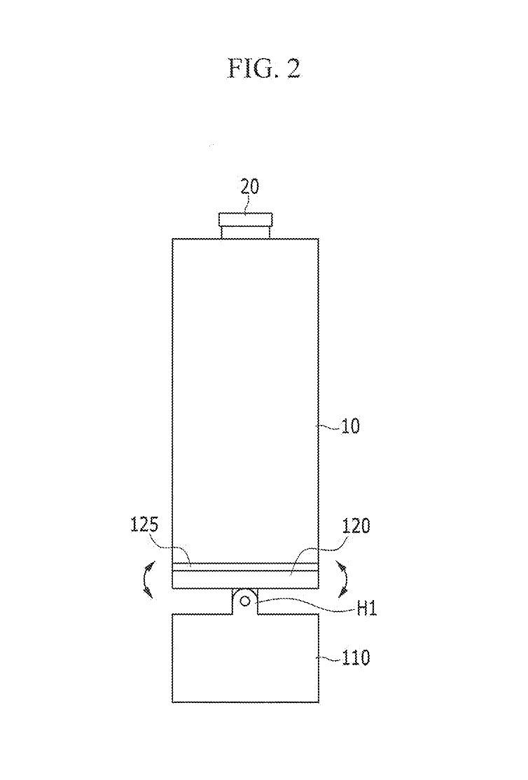

FIG. 1 is a perspective view of a jig apparatus and a rechargeable battery according to an exemplary embodiment of the present invention; and FIG. 2 is a side view of the jig apparatus and the rechargeable battery shown in FIG. 1.

Referring to FIG. 1 and FIG. 2, a jig apparatus 100 according to an exemplary embodiment of the present invention includes a base member 110 and a first rotation member 120.

The base member 110 is formed having a size corresponding to a lower side of a rechargeable battery 10 at which terminals 11 and 12 of the rechargeable battery 10 are not formed. The shape of the base member 110, in one embodiment, may be a plate shape, as an example. The base member 110, one embodiment, may be positioned on a ground surface. Alternatively, the base member 110 may be fixed to a separate frame.

The first rotation member 120 is coupled to an upper side of the base member 110 and is configured to be rotated relative to the base member 110. The shape of the first rotation member 120 may be a plate shape, as an example. The first rotation member 120 may be rotated in a vertical direction (e.g., rotated about a horizontal axis X1) with respect to the base member 110.

For this purpose, the jig apparatus 100 according to an exemplary embodiment may include two first hinge portions H1. The two first hinge portions H1 are respectively formed on ends of the upper side of the base member 110. The two first hinge portions H1 are configured to rotate the first rotation member 120 in the longitudinal direction with respect to the base member 110. That is, the first rotation member 120 is configured to rotate about an axis X1 extending in the longitudinal direction of the base member 110 and is rotatably connected to the base member 120 via the two first hinge portions H1.

The two first hinge portions H1 may be formed in respective center, portions of the two ends of the base member 110. The first rotation member 120 may be rotated about an imaginary rotation axis X1 formed by the two first hinge portions H1.

The rechargeable battery 10 is not fixed, but may be rotated in a direction by the rotation of the first rotation member 120. Conventionally, a rechargeable battery is fixed; however, in the jig apparatus 100 according to an exemplary embodiment of the present invention, since the rechargeable battery 10 may be moved by the first rotation member 120, the rechargeable battery 10 may be stably maintained in close surface contact to a probe 20.

Accordingly, since the probe 20 and the terminals 11 and 12 of the rechargeable battery 10 may be stably surface-contacted, a contact resistance is not increased, thereby preventing or substantially preventing heating and a corresponding effect on the accuracy of a measurement.

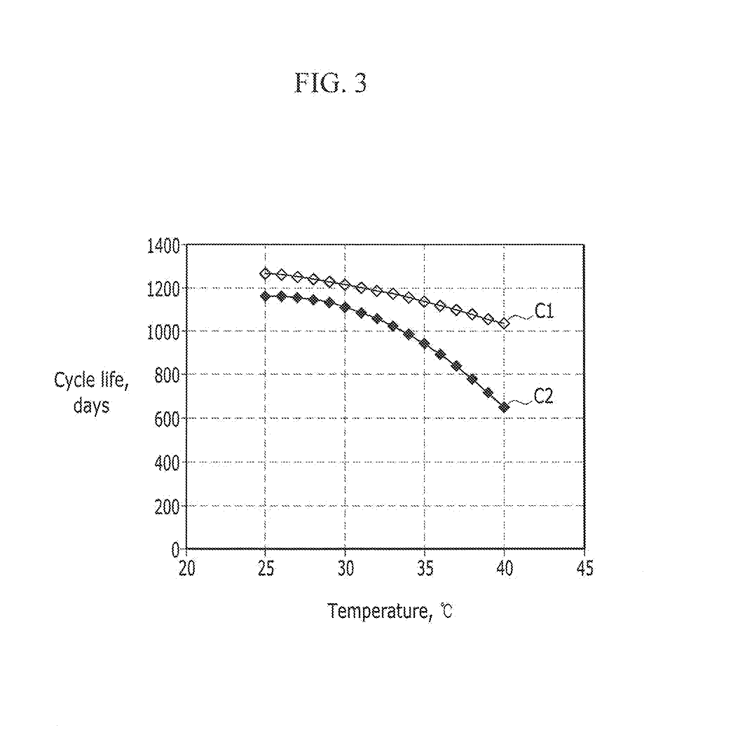

FIG. 3 is a graph showing a cycle-life according to temperatures of two rechargeable batteries. Here, two rechargeable batteries C1 and C2 may each be a disclosed rechargeable battery.

As shown in FIG. 3, when the temperature of one rechargeable battery C1 is 25° C., a period in which a charge capacity is maintained is about 1280 days. However, when the temperature of the rechargeable battery C1 is 40° C., the period in which the charge capacity is maintained is decreased to about 1010 days.

Also, when the temperature of the other rechargeable battery C2 is 25° C., the period in which the charge capacity is maintained is about 1150 days. However, when the temperature of the rechargeable battery C2 is 40° C., the period in which the charge capacity is maintained is decreased to about 650 days.

As described above, it may be confirmed that the cycle-life (a charge capacity number) of two rechargeable batteries C1 and C2 is decreased in the case of 40° C. due to the heating in the rechargeable battery compared with the case in which the rechargeable battery is at 25° C.

When testing the cycle-life of the rechargeable battery 10 (referring to FIG. 1) by the jig apparatus 100 (referring to FIG. 1) according to an exemplary embodiment of the present invention, as described above, heating is not generated, or is minimized or reduced, so the actual performance of the rechargeable battery 10 may be obtained, thereby improving the test reliability.

In one embodiment, the jig apparatus 100 may further include an adhesive layer 125. The adhesive layer 125, in one embodiment, is formed on the upper surface of the first rotation member 120 such that the first rotation member 120 may be adhered to a lower surface of the rechargeable battery 10.

The adhesive layer 125 may be a coated adhesive material, as an example. Alternatively, the adhesive layer 125 may be a double-sided adhesive tape.

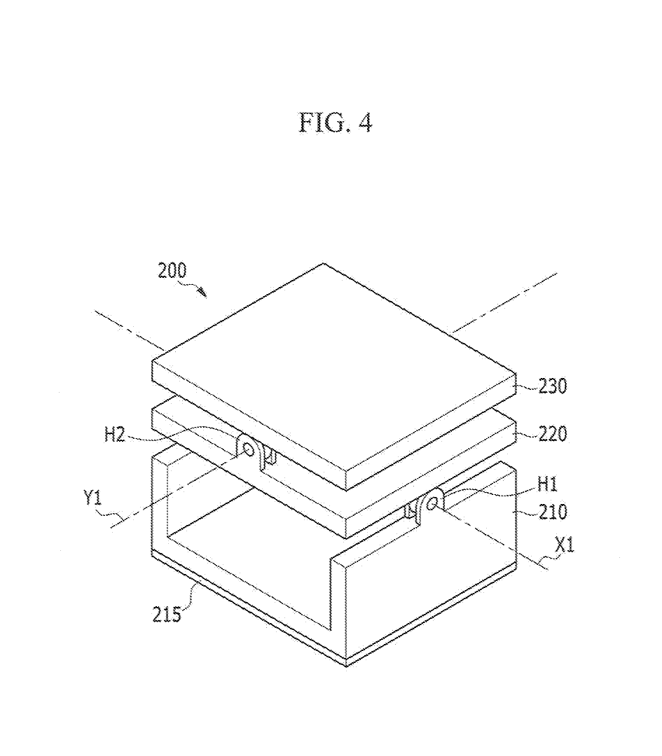

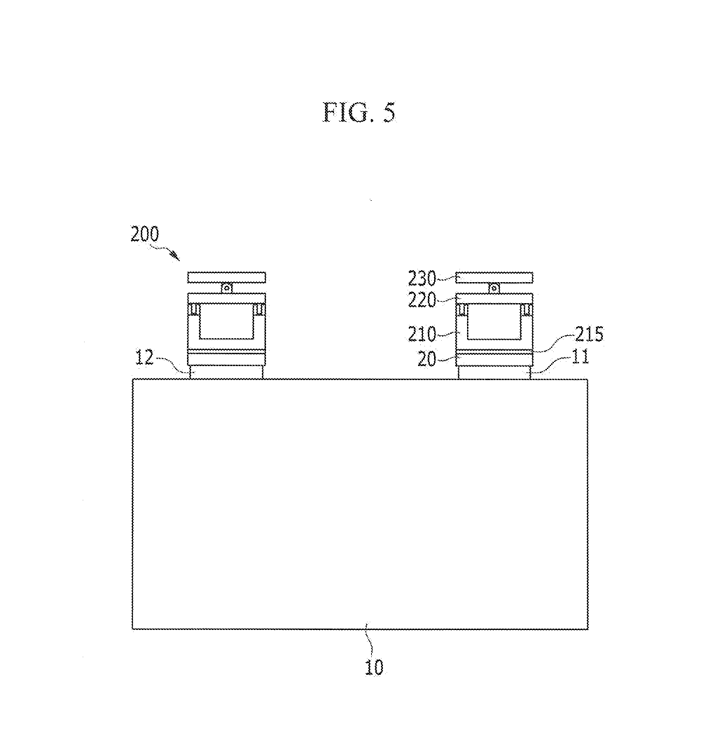

FIG. 4 is a perspective view showing a jig apparatus according to another exemplary embodiment of the present invention; and FIG. 5 is a front view showing a state in which the jig apparatus shown in FIG. 4 is installed to a probe on a rechargeable battery.

Referring to FIG. 4 and FIG. 5, a jig apparatus 200 according to another exemplary embodiment of the present invention includes a base member 210, a first rotation member 220, and a second rotation member 230.

The base member 210 is formed having a size corresponding to the probe 20 installed to the terminals 11 and 12 formed in the upper side of the rechargeable battery 10. There is a difference in that the base member 210 contacts the probe 20 compared with the base member 110 (referring to FIG. 1) included in the jig apparatus 100 (referring to FIG. 1) according to the above-described exemplary embodiment. A lower surface of the base member 210 may contact an upper surface of the probe 20.

The first rotation member 220 is rotatably coupled to an upper side of the base member 210. With the exception of the second rotation member 230, the first rotation member 220, in one embodiment, is configured the same or similarly to the first rotation member 120 (referring to FIG. 1) included in the jig apparatus 100 (referring to FIG. 1) according to the above-described exemplary embodiment, and, therefore, further detailed description is omitted.

The second rotation member 230 is rotatably coupled to an upper side of the first rotation member 220 in a direction perpendicular to the rotation direction of the first rotation member 220. Accordingly, the second rotation member 230 may be rotated about two axes with respect to the base member 210.

For this purpose, the jig apparatus 200 according to the current exemplary embodiment may include two first hinge portions H1 and two second hinge portions H2. Here, the first hinge portions H1 may, be the same as the first hinge portions H1 included in the jig apparatus 100 according to the above-described exemplary embodiment, and, therefore, further detailed description thereof is omitted.

The two second hinge portions H2, in one embodiment, are respectively formed on transverse ends of the upper side of the first rotation member 220. The second hinge portions H2 allow the second rotation member 230 to be rotated in right and left directions (e.g., about an axis Y1 extending in the transverse direction) with respect to the first rotation member 220.

An upper side of the second rotation member 230 may be installed to a separate frame or a separate supporting apparatus (not shown).

The jig apparatus 200 according to an exemplary embodiment of the present invention may further include an adhesive layer 215. The adhesive layer 215, in one embodiment, is formed on the lower surface of the base member 210 such that the base member 210 may be adhered to the upper surface of the probe 20.

The jig apparatus 200 according to an exemplary embodiment has the difference of the second rotation member 230 compared with the jig apparatus 100 (referring to FIG. 1) according to the above-described exemplary embodiment. The second rotation member 230 may be rotated about two axes with respect to the base member 210 such that the probe 20 may be rotated in various directions with respect to the second rotation member 230, such that the probe 20 and the terminals 11 and 12 may be maintained in close surface contact.

The jig apparatus 200 according to the current exemplary embodiment may further improve the contact reliability of the probe 20 and the terminals 11 and 12.

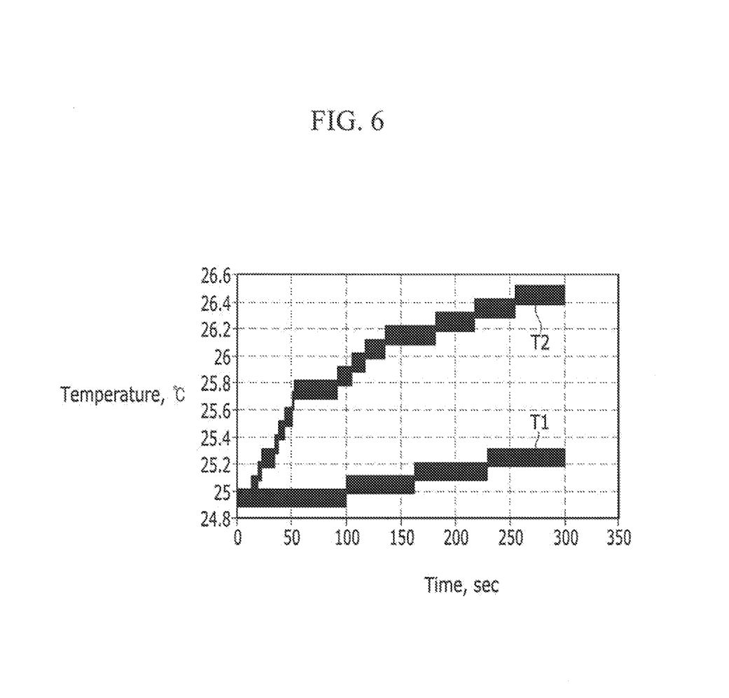

FIG. 6 is a graph showing results of testing a cycle-life of a rechargeable battery by using a jig apparatus according to an exemplary embodiment of the present invention and a conventional jig apparatus.

Here, T1 is a value of measuring the temperature of the rechargeable battery depending on time when testing the cycle-life of the rechargeable battery by using the jig apparatus according to an embodiment of the present invention, and T2 is the value measuring the temperature of the rechargeable battery when testing the cycle-life of the rechargeable battery by using a conventional jig apparatus.

As shown in FIG. 6, when testing the cycle-life of the rechargeable battery using the conventional jig apparatus (T2), the initial temperature is 25° C. and is 26.4° C. after 300 seconds, which is an increase of 1.4° C. As shown, the temperature (T2) of the rechargeable battery by using a conventional jig apparatus is continually increased over time.

However, when testing the cycle-life of the rechargeable battery using the jig apparatus according to an embodiment of the present invention (T1), the initial temperature is 25° C. and is 26.2° C. after 300 seconds, which is an increase of 0.2° C. That is, over time the increase of the temperature of the rechargeable battery is very small by using the jig apparatus according to an embodiment of the present invention.

Through this result, if the cycle-life of the rechargeable battery is tested by using the jig apparatus according to an embodiment of the present invention, the generation of the heating may be minimized or reduced compared with the case of testing the cycle-life of the rechargeable battery by using the conventional jig apparatus.

The drawings referred to above and the detailed description of some exemplary embodiments of the present invention are provided as examples of embodiments of the present invention, and are provided to explain the present invention, but are not intended to limit the meanings or scope of the present invention described in the following claims. Therefore, those skilled in the art should understand that various modifications and other embodiments of the present invention are possible. Accordingly, the scope of the present invention is not intended to be limited by the description of some exemplary embodiments herein, but, rather, should be determined by the spirit of the claims and equivalents thereof.

What is claimed s:

1. A jig apparatus comprising:
a base member having a size corresponding to a lower side of a rechargeable battery in which a terminal is not formed; and
a first rotation member rotatably coupled to an upper side of the base member.

2. The jig apparatus of claim 1, further comprising two first hinge portions respectively arranged at opposite ends of the upper side of the base member to rotate the first rotation member in a first direction with respect to the base member.

3. The jig apparatus of claim 1, further comprising an adhesive layer on an upper surface of the first rotation member to adhere the first rotation member to a lower surface of a rechargeable battery.

4. A jig apparatus comprising:
a base member having a size corresponding to a probe installed to a terminal arranged at an upper side of a rechargeable battery;
a first rotation member rotatably coupled to an upper side of the base member, the first rotation member being rotatable relative to the base member about a first rotation axis; and
a second rotation member rotatably coupled to an upper side of the first rotation member, the second rotation member being rotatable relative to the first rotation member about a second rotation axis that is perpendicular to the first rotation axis.

5. The jig apparatus of claim 4, further comprising:
two first hinge portions respectively arranged at opposite ends of the upper side of the base member in a lengthwise direction to rotate the first rotation member with respect to the base member about the first rotation axis; and
two second hinge portions respectively arranged at opposite ends of the first rotation member in a lateral direction to rotate the second rotation member with respect to the first rotation member about the second rotation axis.

6. The jig apparatus of claim 4, further comprising an adhesive layer on a lower surface of the base member to adhere the base member to an upper surface of a probe.

7. The jig apparatus of claim 4, further comprising a probe in close surface contact with a lower surface of the base member.

8. The jig apparatus of claim 7, further comprising an adhesive layer on the lower surface of the base member to adhere the base member to a surface of the probe.
